(19) United States
(12) Patent Application Publication
(10) Pub. No.: US 2011/0180298 A1
(43) Pub. Date: Jul. 28, 2011

(54) HYDROUS WATER ABSORBENT POLYMER-DISPERSED ULTRAVIOLET CURABLE RESIN COMPOSITION, POROUS SUBSTANCE, INSULATED WIRE, MULTILAYER COVERED CABLE, COAXIAL CABLE USING THE SAME, METHOD FOR FABRICATING A POROUS SUBSTANCE, AND METHOD FOR FABRICATING AN INSULATED WIRE

(75) Inventors: Yoshihisa KATO, Takahagi (JP); Tomiya Abe, Hitachi (JP)

(73) Assignee: HITACHI CABLE, LTD.

(21) Appl. No.: 12/983,502

(22) Filed: Jan. 3, 2011

(30) Foreign Application Priority Data
Jan. 26, 2010 (JP) 2010-014542
Jan. 26, 2010 (JP) 2010-014543
Nov. 24, 2010 (JP) 2010-260779
Nov. 24, 2010 (JP) 2010-260780

(51) Int. Cl. H01B 7/18; B01J 20/26; B05D 5/12; H01B 3/30

(52) U.S. Cl. 174/102 R; 502/402; 521/157; 427/513; 521/50.5; 174/110 SR

(57) ABSTRACT

A hydrous water absorbent polymer-dispersed ultraviolet curable resin composition, a porous substance, an insulated wire, a multilayer covered cable, a coaxial cable using the same, a method for manufacturing the porous substance and a method for manufacturing the insulated wire using the same. A hydrous water absorbent polymer preliminarily hydrated and swollen is dispersed in an ultraviolet curable resin composition. The ultraviolet curable resin composition includes an urethane oligomer having a molecular weight of 5000 or less and having a poly(ethylene-glicol-adipate)diol having a molecular weight of 500 to 3000 and having an acryloyl radical or a methacryloyl radical as a functional radical X at both ends by urethane bond via an alicyclic isocyanate as expressed by a following formula, at least one kind of alicyclic monomer, a hydrophilic monomer, and a photopolymerization initiator. 0.01 mass % to 0.5 mass % of a non-ionic fluorine based surface active agent or a non-ionic silicone-based surface active agent may be added to the resin composition.

The present application is based on Japanese Patent Application No. 2010-014542 filed on Jan. 26, 2010, Japanese Patent Application No. 2010-014543 filed on Jan. 26, 2010, Japanese Patent Application No. 2010-260779 filed on Nov. 24, 2010, and Japanese Patent Application No. 2010-260780 filed on Nov. 24, 2010, the entire contents of which are incorporated herein by reference.

### BACKGROUND OF THE INVENTION

1. Field of the Invention

The invention relates to a hydrous water absorbent polymer-dispersed ultraviolet curable resin composition for forming an insulation layer formed of a porous film, a porous substance, an insulated wire, a multilayer covered cable, a coaxial cable using the same, a method for fabricating a porous substance and a method for fabricating an insulated wire.

2. Description of the Related Art

In recent years, in accordance with downsizing or high-density mounting of precision electronic devices or communication devices in medical and other fields, a diameter of a wire/cable used for those devices is more and more reduced. Furthermore, the trend of further high-speed transmission signal is remarkable for a signal line, etc., and it is desired to speed up the transmission signal by thinning an insulation layer of a wire used therefor and decreasing dielectric constant as much as possible.

A foamed insulating material having low dielectric constant such as a polyethylene or fluorine resin is used for a conventional insulation layer. A method in which a pre-foamed film is formed on a conductor or an extrusion method is known for forming a foamed insulation layer, and especially the extrusion method is widely used.

A foam forming method is roughly classified into a physical foaming method and a chemical foaming method.

The physical foaming method includes a method in which a volatile foaming liquid such as liquefied chlorofluorocarbon is injected into a molten resin to make foams by the vaporization pressure, or a method in which a foaming gas such as nitrogen gas or carbon dioxide gas is directly injected into a molten resin in an extruder to generate uniformly-distributed cellular fine independent foam body in the resin (JP-A 2003-26846).

The chemical foaming method is well known in which formation is carried out in a state that an foaming agent is dispersively mixed in the resin, a decomposition reaction of the foaming agent is subsequently generated by applying heat, and foams are produced by using gas generated by the decomposition (JP-A 11-176262 and JP-A 62-236837).

In place of the extrusion method, a thin coating method is used. As the thin coating method, coating of thermo-setting resin for enamel wires and coating of ultraviolet curable resin for optical fibers have been known.

### SUMMARY OF THE INVENTION

However, in the method of injecting the volatile foaming liquid into the molten resin, the vaporization pressure is high and fine formation or uniform formation of foams is difficult, thus, there is a limit to thin formation. In addition, since the injection speed of the volatile foaming liquid is slow, there is a problem such that it is difficult to increase the production speed and the productivity is inferior. Furthermore, in the method of directly injecting the foaming gas in the extruder, since there is a limit to a small-diameter thin extrusion and a special facility or technology is required for safety, there is a problem that the productivity is inferior and the production cost increases.

On the other hand, the chemical foaming method has a problem such that, since the foaming agent is preliminarily kneaded an dispersively mixed in the resin and is then foamed by a gas which is generated by reacting and decomposing the foaming agent by heat after the formation process, there is a problem that the formation process temperature of the resin needs to be kept lower than the decomposition temperature of the foaming agent Furthermore, when a diameter of wire is small, there is another problem in an extrusion coating such that the wire breakage is likely to occur and it is thus difficult to increase speed.

In addition, there are problems that environmental load of the physical foaming method using chlorofluorocarbon, butane and carbon dioxide gases etc., is high and that the foaming agent used for the chemical foaming method is expensive.

On the other hand, in the coating method using liquid material such as thermosetting resin or ultraviolet curable resin which is effective for thin coating, for example, a coating film of thermosetting resin is formed by simultaneously vaporizing and baking the solvent which is a main component in the resin material. However, since a film thickness provided by coating for one time is several nanometers (nm) or less, multilayer coating is required, so that it is difficult to form a foam layer (porous layer). In addition, in a stranded (twisted) conductor, there is a problem in that the solvent permeates into clearances between the conductors and unvaporized solvent remains in this parts so that blister of the coating occurs due to gas generated from this remaining solvent which is heated at later process. Even more particularly, there is a problem in that the environmental load is large since the solvent is used.

Further, when the ultraviolet curable resin is used, it is easy to form the resin coating without using the solvent, so that it is useful for the thin high-speed coating. However, the ultraviolet curable resin is inferior in flexibility and thermal shock resistance property that are required for the coating layer for the electric wire cables. Further, there is a problem in that crack, breakage or the like of the coating may easily occur due to bending in e.g. self-wrapping.

As alternative methods, the Inventors have studied various methods for forming the porous layer by dispersing a hydrous water absorbent polymer in liquid crosslinked type curable resin, and dehydrating the resin after curing. According to this method, it is possible to speedup the process easily and reduce the environmental load. However, a particle diameter (grain size) of the water absorbent polymer will affect on miniaturization of a pore diameter (pore size). Therefore, it is necessary to use the water absorbent polymer granulated as superfine particles. However, the hydrous water absorbent polymer granulated as the superfine particles is gel, and easily agglomerate. Therefore, even though such a hydrous water absorbent polymer is added to the resin, it will be difficult to finely disperse the hydrous water absorbent polymer in the resin. On the contrary, the pore diameter (pore size) will be enlarged.

Accordingly, the present invention is obtained as a result of various studies for solving the above problems.

It is an object of the invention to provide a hydrous water absorbent polymer-dispersed ultraviolet curable resin, a porous substance, an insulated wire, a multilayer covered cable, a coaxial cable using the same, a method for fabricating a porous substance, and a method for fabricating an insulated wire and a coaxial cable, which is eco-friendly, facilitates formation of homogeneous microvoid, and easily corresponds to reduction in diameter and reduction in thickness.

A first feature of the invention provides a hydrous water absorbent polymer-dispersed ultraviolet curable resin composition comprising an ultraviolet curable resin composition having a hydrous water absorbent polymer preliminarily hydrated and swollen which is dispersed therein, an urethane oligomer having a molecular weight of 5000 or less, the urethane oligomer comprising a poly(ethylene-glicol-adipate)diol having a molecular weight of 500 to 3000 and having an acryloyl radical or a methacryloyl radical as a functional radical X at both ends by urethane bond via an alicyclic isocyanate as expressed by a following formula, at least one kind of alicyclic monomer, a hydrophilic monomer, and a photopolymerization initiator,

X—Y—O(CH₂CH₂)ₙOCO(CH₂)₄COO(CH₂CH₂)ₘO—Y—X,

wherein X is CH₂═CRCOO(CH₂)ₐO (R is H or CH₃) and Y is the alicyclic isocyanate

The hydrous water absorbent polymer-dispersed ultraviolet curable resin composition may further comprise:

0.01 mass % to 0.5 mass % of a non-ionic fluorine based surface active agent or a non-ionic silicone-based surface active agent.

The alicyclic isocyanate may comprise a methylenebis (4-cyclohexyl isocyanate).

A ratio of the oligomer in the ultraviolet curable resin except the hydrous water absorbent polymer is preferably 40 mass % to 70 mass %, and a ratio of the hydrophilic monomer is preferably 10 mass % or more.

The hydrophilic monomers preferably comprises at least one selected from the group consisting of vinyl pyrrolidone, N,N-dimethylaminoethyl methacrylate, 2-hydroxyethyl acrylate, 2-hydroxyethyl methacrylate and hydroxypropyl acrylate.

A viscosity of the ultraviolet curable resin except the hydrous water absorbent polymer at a temperature of 25° C. is preferably 1 to 10 Pas.

A moisture content in the hydrous water absorbent polymer-dispersed ultraviolet curable resin composition is preferably 20 mass % or more.

A particle diameter of the hydrous water absorbent polymer is preferably 30 μm or less.

The non-ionic fluorine based surface active agent or the non-ionic silicone-based surface active agent preferably comprises at least one selected from the group consisting of perfluoroalkyl radical-containing polyoxyethylene ether, polyether-modified polydimethylsiloxane, and polyether-modified polymethyl alkylsiloxane.

A second feature of the invention provides a porous substance, formed by curing the hydrous water absorbent polymer-dispersed ultraviolet curable resin composition according to the first feature and dehydrating the hydrous water absorbent polymer to provide a pore in the ultraviolet curable resin composition.

A third feature of the invention provides an insulated wire comprising:

an insulation layer formed by coating an outer periphery of stranded conductors with the porous substance according to the second feature.

A thickness of the insulation layer is preferably not more than 200 μm, and a porosity thereof is preferably 20% to 60%.

A cross section of the pore that forms a void in the insulation layer is preferably in a substantially circular cross section, a ratio of a maximum diameter portion thereof and a minimum diameter portion is preferably not more than 2, and a pore size D in a thickness direction is preferably formed so as to be D<½ t where a thickness of the insulation layer is t.

A fourth feature of the invention provides a multilayer covered cable comprising a skin layer provided on an outer periphery of the insulated wire.

A fifth feature of the invention provides a coaxial cable comprising:

a metal layer provided on an outer periphery of the insulated wire according to the third feature.

A sixth feature of he invention provides a method of manufacturing a porous substance, comprising:

dispersing a hydrous water absorbent polymer preliminarily hydrated and swollen in an ultraviolet curable resin composition comprising an urethane oligomer having a molecular weight of 5000 or less, the urethane oligomer comprising a poly(ethylene-glicol-adipate)diol having a molecular weight of 500 to 3000 and having an acryloyl radical or a methacryloyl radical as a functional radical X at both ends by urethane bond via an alicyclic isocyanate, at least one kind of alicyclic monomer, a hydrophilic monomer, and a photopolymerization initiator,

curing the hydrous water absorbent polymer-dispersed ultraviolet curable resin composition, and

heating the cured resin composition for removing moisture in the hydrous water absorbent polymer to provide a pore in the cured resin composition.

The hydrous water absorbent polymer is preferably dispersed in the ultraviolet curable resin composition after doping 0.01 mass % to 0.5 mass % of a non-ionic fluorine based surface active agent or a non-ionic silicone-based surface active agent to the ultraviolet curable resin composition.

A microwave heating may be used as the heating.

A seventh feature of the invention provides a method of manufacturing an insulated wire comprising:

coating an outer periphery of a conductor with a hydrous water absorbent polymer-dispersed ultraviolet curable resin composition comprising an ultraviolet curable resin composition having a hydrous water absorbent polymer preliminarily hydrated and swollen which is dispersed therein, an urethane oligomer having a molecular weight of 5000 or less, the urethane oligomer comprising a poly(ethylene-glicol-adipate)diol having a molecular weight of 500 to 3000 and having an acryloyl radical or a methacryloyl radical as a functional radical X at both ends by urethane bond via an alicyclic isocyanate as expressed by a following formula, at least one kind of alicyclic monomer, a hydrophilic monomer, and a photopolymerization initiator,

forming an insulation layer by curing the resin composition, and

heating the cured resin composition for removing moisture in the insulation layer, thereby forming pores in the insulation layer.

### Advantages of the Invention

According to a hydrous water absorbent polymer-dispersed ultraviolet curable resin, a porous substance, an insulated wire, a multilayer covered cable, a coaxial cable using the same, a method for fabricating a porous substance and a method for fabricating an insulated wire in one embodiment of the present invention, it is possible to be eco-friendly, and facilitate formation of homogeneous microvoids.

According to the hydrous water absorbent polymer-dispersed ultraviolet curable resin, a porous substance, an insulated wire, a multilayer covered cable, a coaxial cable using the same, a method for fabricating a porous substance and a method for fabricating an insulated wire in one embodiment of the present invention, it is possible to satisfy the flexibility and the thermal shock resistance property that are required for the coating layer of the electric wires and cables, and to suppress the breakage or cracks due to the bending.

According to the hydrous water absorbent polymer-dispersed ultraviolet curable resin, a porous substance, an insulated wire, a multilayer covered cable and a coaxial cable using the same, a method for fabricating a porous substance and a method for fabricating an insulated wire in another embodiment of the present invention, it is further possible to reduce the diameter of hole for superfinely dispersing the hydrous water absorbent polymer and to improve the film-forming property (film forming property) at a thin thickness.

According to the hydrous water absorbent polymer-dispersed ultraviolet curable resin, a porous substance, an insulated wire, a multilayer covered cable and a coaxial cable using the same, a method for fabricating a porous substance and a method for fabricating an insulated wire in another embodiment of the present invention, it is further possible to lower electrical properties such as permittivity, electrostatic capacitance.

### BRIEF DESCRIPTION OF THE DRAWINGS

Next, the present invention will be explained in more detail in conjunction with appended drawings, wherein:

FIG. 1 is a horizontal cross sectional view showing an insulated wire in a first preferred embodiment of the present invention, in which an insulation layer is formed of a porous substance;

FIG. 2 is a horizontal cross sectional view showing a multilayer covered cable using the insulated wire in the first embodiment of the invention;

FIG. 3 is a horizontal cross sectional view showing a coaxial cable using the insulated wire in the first embodiment of the invention;

FIG. 4 is a microscope photograph showing a 200-times enlarged cross section of a 200 μm thick film obtained in Example 1 of the first embodiment of the present invention;

FIG. 5 is a microscope photograph showing a 200-times enlarged cross section of a coaxial cable with a 100 μm thick film obtained in Example 1 of the first embodiment of the present invention;

FIG. 6 is a microscope photograph showing a 200-times enlarged cross section of a 200 μm thick film obtained in Example 5 of a second embodiment of the present invention;

FIG. 7 is a microscope photograph showing a 200-times enlarged cross section of a 200 μm thick film obtained in Comparative example 7 of the second embodiment of the present invention; and

FIG. 8 is a microscope photograph showing a 200-times enlarged cross section of a coaxial cable with a 100 μm thick film obtained in Example 5 of the second embodiment of the present invention.

### DESCRIPTION OF THE PREFERRED EMBODIMENTS

Next, the embodiments of the invention will be described below with reference to the appended drawings.

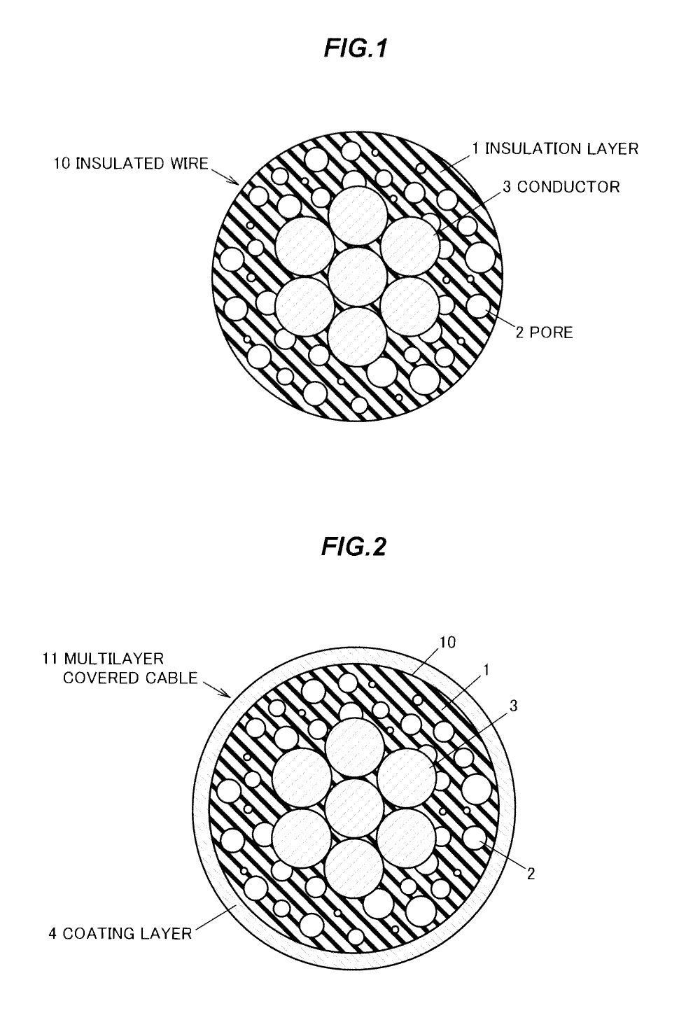

Firstly, an insulated wire, a multilayer covered cable and a coaxial cable to which a hydrous water absorbent polymer-dispersed ultraviolet curable resin composition of the invention is applied will be explained with referring to FIGS. 1 to 3.

### (Structure of an Insulated Wire)

FIG. 1 is a horizontal cross sectional view of an insulated wire. An insulated wire 10 is formed by coating an outer periphery of plural conductors 3 with an insulation layer 1 formed of a hydrous water absorbent polymer-dispersed ultraviolet curable resin composition having fine pores 2.

### (Structure of a Multilayer Covered Cable)

FIG. 2 is a horizontal cross sectional view of a multilayer covered cable using the insulated wire 10 shown in FIG. 1. A multilayer covered cable 11 is formed by forming a skin layer or a coating layer 4 on an outer periphery of the insulated wire 10.

### (Structure of a Coaxial Cable)

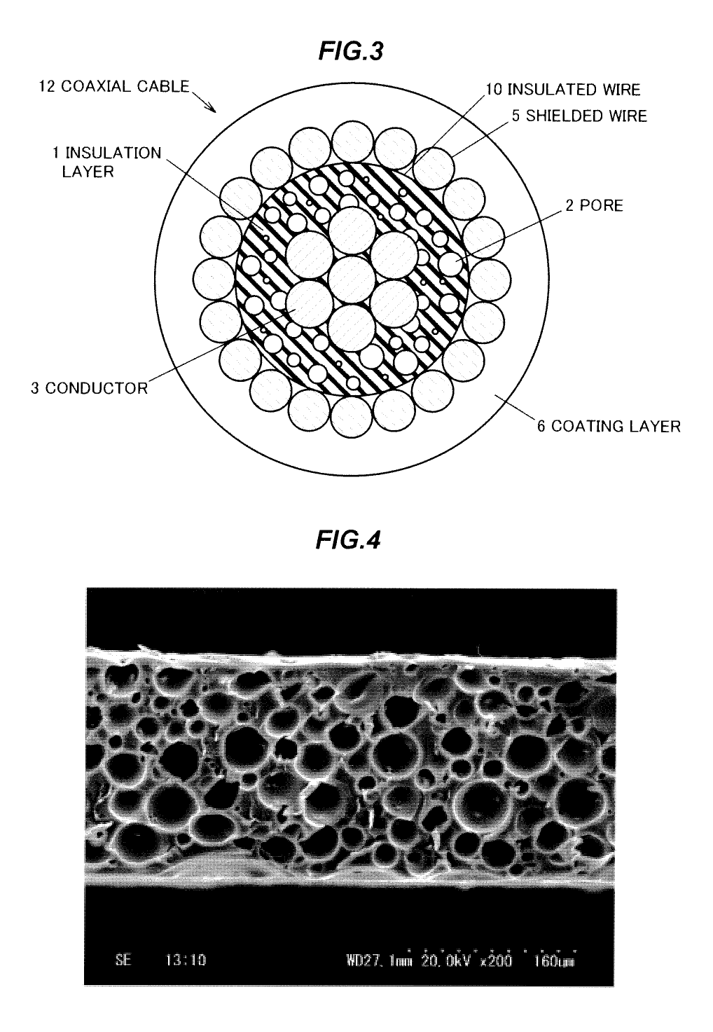

FIG. 3 is a horizontal cross sectional view of a coaxial cable using the insulated wire 10 shown in FIG. 1. Shielded wires or shield layers 5 are formed on an outer periphery of the insulation layer 1 of the insulated wire 10 using the conductor 3 of the insulated wire 10 as an inner conductor, and a coating layer 6 is formed on a further outer periphery thereof, thereby forming a coaxial cable 12

### First Embodiment

The first embodiment of the present invention provides a hydrous water absorbent polymer-dispersed ultraviolet curable resin composition comprising an ultraviolet curable resin composition having hydrous water absorbent polymer preliminarily hydrated and swollen which is dispersed therein, an urethane oligomer having a molecular weight of 5000 or less, the urethane oligomer comprising a poly(ethylene-glicol-adipate)diol having a molecular weight of 500 to 3000 and having an acryloyl radical or a methacryloyl radical as a functional radical X at both ends by urethane bond via an alicyclic isocyanate (i.e. alicyclic isocyanate-mediated urethane bond) as expressed by a following formula (1), at least one kind of alicyclic monomer, a hydrophilic monomer, and a photopolymerization initiator,

X—Y—O(CH₂CH₂)ₙOCO(CH₂)₄COO(CH₂CH₂)ₘO—Y—X (1),

wherein X is CH₂═CRCOO(CH₂)ₐO (R is H or CH₃) and Y is the alicyclic isocyanate

### (Ultraviolet Curable Resin)

The ultraviolet curable resin composition has a dielectric constant of 4 or less, preferably 3 or less.

### (Water Absorbent Polymer)

The water absorbent polymer is a polymer material that absorbs water very well and does not discharge absorbed water due to its high water-holding ability even when some pressure is applied. For example, hydrolysate of starch-acrylonitrile graft polymer, starch-acrylic acid graft polymer, a hydrolysate of vinyl acetate-acrylic acid ester copolymer, cross-linked polyacylate, carboxymethylated cellulose, polyalkylene oxide system resin and polyacrylamide system resin etc are included.

The hydrous water absorbent polymer is a water absorbent polymer with water absorbed therein. The reason why the water absorbent polymer with the absorbed water is dispersed is that, since the size and shape of the pore can be controlled by the particle diameter of the water absorbent polymer and the amount of water absorption, the water absorbent polymer which is gelled by the water absorbing and swelling contains much water and the liquid ultraviolet curable resin composition is not compatible with water, it is easily independently dispersed and easily dispersed by forming a sphere shape when being agitated and dispersed. Thus, the pore shape obtained by dehydration after curing can be close to a spherical shape and the resistance to the collapse is likely to be obtained. The particle diameter of the hydrous water absorbent polymer is preferably 30 μam or less.

Especially, it is preferable that the water absorbent polymer does not contain sodium and the amount of water absorption thereof is 20 g/g or more. The polyalkylene oxide system resin is most representative. The reason why sodium is not contained is that it is likely to cause a decrease in electrical insulating properties. The amount of water absorption is an amount of water (g) absorbed per 1 g of water absorbent polymer, and when the amount of water absorption is smaller than 20 g/g, pore formation efficiency decreases and it is necessary to use many water absorbent polymers.

### (Urethane Oligomer)

In the present invention, since the urethane oligomer is formed to have a chemical structure expressed by chemical formula (1), it is possible to provide excellent ductility and flexibility. In addition, it is also possible to suppress the crush of the pores in the porous layer and the cracks due to bending.

The reason why the molecular weight of the urethane oligomer is set to be 5000 or less is as follows. If the molecular weight of the urethane oligomer is greater than 5000, viscosity of the resin will be high and handling workability will be deteriorated. In addition, dispersibility of the hydrous water absorbent polymer will be deteriorated.

Adjustment of the viscosity can be facilitated by using the alicyclic monomer and the hydrophilic monomer. The alicyclic monomer suppresses volume contraction and relaxes distortion in the ultraviolet curing, thereby suppressing the cracks due to bending or thermal shock The hydrophilic monomer accelerates independent dispersion of the hydrous water absorbent polymer, thereby facilitating formation of the porous layer.

### (Alicyclic Monomer)

As the alicyclic monomer, known materials such as cyclohexyl(meth)acrylate, tetrahydrofurfuryl(meth)acrylate, isobornyl(meth)acrylate, dicyclopentynyl(meth)acrylate, dicyclopentenyl(meth)acrylate, dicyclopentynylxyethyl(meth)acryate may be used. It is preferable to use dicyclopentenyl(meth)acrylate or isobornyl(meth)acrylate.

Further, in the present invention, methylenebis (4-cyclohexyl isocyanate) is used as the alicyclic isocyanate, so that it is possible to keep the flexibility and suppress the distortion in the ultraviolet curing, thereby suppressing the cracks due to bending or thermal shock.

It is preferable that a ratio of the oligomer in the ultraviolet curable resin except the hydrous water absorbent polymer is 40 mass % to 70 mass %. If the ratio of the oligomer in the ultraviolet curable resin is less than 40 mass %, the cracks due to bending or thermal shock will easily occur, and the resin composition will be fragile. On the other hand, if the ratio of the oligomer in the ultraviolet curable resin is more than 70 mass %, viscosity of the resin composition will be increased, so that the handling workability and the dispersibility of the hydrous water absorbent polymer will be deteriorated.

The reason why a ratio of the hydrophilic monomer in the ultraviolet curable resin composition is 10 mass % or more is that an effect of film-forming properties is not obtained at less than 10 mass % when the moisture content is increased by dispersing the hydrous water absorbent polymer. The upper limit of the ratio of the hydrophilic monomer is not specifically limited, however, 50 mass % or less is desirable. It is because, even if the value is above this, an effect in the film-forming properties is reduced and it becomes difficult to obtain a property balance such as flexibility or mechanical characteristics.

### (Hydrophilic Monomer)

As the hydrophilic monomer, at least one kind of hydrophilic monomer is selected from the group consisting of vinyl pyrrolidone, N,N-dimethylaminoethyl methacrylate, 2-hydroxyethyl acrylate, 2-hydroxyethyl methacrylate and hydroxypropyl acrylate, since it is very effective for obtaining the film-forming properties when the moisture content is increased. Alternatively, it is possible to use known hydrophilic monomer, e.g., by butanediol monoacrylate, t-butylaminoethyl methacrylate, N,N-dimethylaminoethyl acrylate, N,N-diethylaminoethyl acrylate, 2-ethoxyethyl acrylate, n-hexyl acrylate, hydroxypropyl methacrylate, neopentyl glycol diacrylate, polyethylene glycol 400 diacrylate, polypropylene glycol monoacrylate, polyethylene glycol monomethacrylate, tetrahydrofurfuryl acrylate, tetrahydrofurfuryl methacrylate, N-vinyl acetate or vinyl caprolactam, etc.

It is preferable to use one or more selected from the group consisting of vinyl pyrrolidone, N,N-dimethylaminoethyl methacrylate, 2-hydroxyethyl acrylate, 2-hydroxyethyl methacrylate and hydroxypropyl acrylate, since it is very effective for obtaining the film-forming properties when the moisture content is increased. The additive amount of the hydrophilic monomer is preferably 10 mass % or more and 50 mass % or less. If the additive amount is less than 10 mass %, the formation of the porous layer by the dispersion of the hydrous water absorbent polymer will be deteriorated remarkably. If the additive amount is greater than 50 mass %, the film-forming property will be affected as well as the flexibility and the balance in mechanical properties will be hardly obtained.

In the hydrous water absorbent polymer dispersion ultraviolet curable resin composition of the present invention, viscosity of the ultraviolet curable resin except the hydrous water absorbent polymer at a temperature of 25° C. is preferably 1 to 10 Pas. If the viscosity is less than 1 Pas, it will be difficult to provide a sufficient film thickness at the time of coating. On the other hand, if the viscosity is greater than 10 Pas, dispersion of the hydrous water absorbent polymer will be difficult, so that the formation of the porous layer will be difficult. In addition, it is necessary to elevate heating temperature for lowering the viscosity. If the heating temperature is high, the moisture may easily evaporate from the resin composition, so that a moisture content fluctuates and tends to be lowered. Further, dew drop condensation easily occurs in a container in the process that the temperature falls, thereby decreasing preservation stability. In re-agitation process, a condensation water drop may be mixed into the resin, so that coating irregularity may occur in the coating process.

The moisture content in the ultraviolet curable resin composition with the hydrous water absorbent polymer dispersed therein is preferably 20 mass % or more, since it is difficult to obtain a dielectric constant lower than that of PFA which is thermoplastic resin, fluorine system resin such as ETFE or polyethylene, if the moisture content ratio is lower than 20 mass % The moisture content ratio is more preferably 30 mass % to 70 mass %. If the moisture content ratio is greater than 70 mass %, formation of stable porous layer will become significantly difficult. Most preferably, the moisture content ratio is 35 mass % to 65 mass %

The reason for conducting the dehydration by heating after curing by ultraviolet rays is that the reduction in porosity due to the volume contraction by the dehydration can be prevented and the change in film thickness or outer diameter can be prevented, thereby obtaining the stabilization. Furthermore, since the coating can be formed preliminarily including portions to be pores, it is not necessary to foam and reduction in adhesiveness is not caused by swelling or separation between the conductor and the foamed layer which may occur in the conventional gas foaming process by gas injection or foaming agent, thereby obtaining the stabilization.

### (Other Additive Elements)

The hydrous water absorbent polymer-dispersed ultraviolet curable resin composition can be used with addition of, according to need, a dispersing agent, a leveling agent, a coupling agent, a coloring agent, a flame retardant, an antioxidant, an electrical insulation improver or a filler etc which are conventionally known.

### (Configuration of the Insulated Wire)

According to the present invention, the insulated wire has an insulation layer having a thickness of 200 μm or less and a porosity of not less than 20% nor more than 60%, the pore to be formed is in a substantially circular cross section, the ratio of the maximum diameter portion and the minimum diameter portion of the pore is 2 or less and a pore size (pore diameter) D in a thickness direction to the insulation layer thickness t is set to be D<½ t. The reason is that a small diameter and high-speed transmission signal are being developed for a coaxial cable as typified by a medical probe cable in which thinning an insulation layer and decreasing dielectric constant are essential and that the pore formation is effective for lowering the dielectric constant of the insulation layer. However, a problem occurs in which, when the porosity is too high or the pore size is too large, the insulation layer is likely to be collapsed and a stable signal transmission is not obtained, hence, it is for obtaining an insulated wire which is thin, low in dielectric constant and excellent in crush resistance.

The reason why the porosity of the insulation layer is not less than 20% nor more than 60% is that the low dielectric constant effect is insufficient when the porosity is less than 20% and formability and crush resistance, etc., of the insulation layer are likely to be reduced when the porosity exceeds 60%

The reason why the ratio of the maximum diameter portion and the minimum diameter portion of the pore is 2 or more is that the collapse is likely to occur when larger than 2.

The reason why the pore size (pore diameter) D in a thickness direction to the insulation layer thickness t is set to be D<½ t is that there is a problem in that the higher the porosity is, the more likely it is that the collapse occurs when larger than ½ t.

In the water absorbent polymer, since the size or shape of the pore can be adjusted by the particle diameter and the amount of water absorption of the water absorbent polymer, furthermore, since the insulation layer can be formed in a state that the portions to be pores are preliminarily formed in the composition, it is possible to facilitate the control.

Herein, the pore size D and a grain size d of the water absorbent polymer is substantially equal to each other. Similarly to the pore, the grain size (particle diameter) d of the water absorbent polymer in a thickness direction to the insulation layer thickness t is set to be d<½ t.

The reason why microwave heating is used for thermal dehydration of water in the water absorbent polymer with the absorbed water is that, since the water is rapidly heated by microwave, the thermal dehydration is possible in short time and a pore is thereby efficiently formed without affecting the water absorbent polymer or the peripheral resin. In addition, continuous thermal dehydration is possible by using a waveguide microwave furnace.

### Second Embodiment

The second embodiment of the present invention provides a hydrous water absorbent polymer-dispersed ultraviolet curable resin composition comprising an ultraviolet curable resin composition having a hydrous water absorbent polymer preliminarily hydrated and swollen which is dispersed therein, an urethane oligomer having a molecular weight of 5000 or less, the urethane oligomer comprising a poly(ethylene-glicol-adipate)diol having a molecular weight of 500 to 3000 and having an acryloyl radical or a methacryloyl radical as a functional radical X at both ends by urethane bond via an alicyclic isocyanate (i.e. alicyclic isocyanate-mediated urethane bond) as expressed by a following formula (1), at least one kind of alicyclic monomer, a hydrophilic monomer, and a photopolymerization initiator,

wherein the hydrous water absorbent polymer preliminarily hydrated and swollen which is dispersed in the ultraviolet curable resin composition is doped with 0.01 mass % to 0.5 mass % of a non-ionic fluorine based surface active agent or a non-ionic silicone-based surface active agent,

X—Y—O(CH₂CH₂)ₙOCO(CH₂)₄COO(CH₂CH₂)ₘO—Y—X (1),

wherein X is CH₂═CRCOO(CH₂)ₐO (R is H or CH₃) and Y is alicyclic isocyanate.

In other words, the second embodiment is different from the first embodiment in that the ultraviolet curable resin composition doped with 0.01 mass % to 0.5 mass % of a non-ionic fluorine based surface active agent or a non-ionic silicone-based surface active agent is used, when the hydrous water absorbent polymer preliminary hydrated and swollen is dispersed in the ultraviolet curable resin composition. The second embodiment will be explained below in more detail, in which explanation common or similar to that of the first embodiment will be omitted.

### (Non-Ionic Surface Active Agent)

The reason why the resin composition is doped with the non-ionic fluorine based surface active agent or the non-ionic silicone-based surface active agent to the resin composition is that an ionic surface active agent may deteriorate electrical insulation property.

As the fluorine based surface active agent, perfluoroalkyl radical-containing polyoxyethylene ether such as F-443, F-444, and F-445 (all products are manufactured by DIC Corporation), perfluoroalkyl radical/hydrophilic radical/lipophilic radical-containing oligomer such as F-470, F-471, F-475, F-477, F-478, and F-479 (all products are manufactured by DIC Corporation), perfluoroalkyl radical/hydrophilic radical-containing oligomer such as F-480FS and F-484 (both products are manufactured by DIC Corporation), perfluoroalkyl radical/lipophilic radical-containing oligomer such as F-487 and F-172D (both products are manufactured by DIC Corporation), and the like may be used. More particularly, perfluoroalkyl radical-containing polyoxyethylene ether is preferable.

As the silicone based surface active agent, it is preferable to use non-reactive silicone oil, more preferably side-chain modified silicone oil. For example, polyether-modified silicone oil, aralkyl-modified silicone oil, fluoroalkyl-modified silicone oil, long-chain alkyl-modified silicone oil, phenyl-modified silicone oil or the like may be used. More particularly, it is preferable to use polyether-modified polydimethylsiloxane, and polyether-modified polymethyl alkylsiloxane.

Therefore, the non-ionic fluorine based surface active agent or the non-ionic silicone-based surface active agent preferably comprises at least one selected from the group consisting of perfluoroalkyl radical-containing polyoxyethylene ether, polyether-modified polydimethylsiloxane, and polyether-modified polymethyl alkylsiloxane.

As to additive amount of the surface active agent, 0.01 to 0.5 mass % is preferable. If the additive amount is less than 0.01 mass %, it will be difficult to obtain fine dispersion effect of hydrous water absorbent polymers. If the additive amount of the surface active agent is greater than 0.5 mass %, it may be impossible to obtain the fine dispersion effect of the hydrous water absorbent polymer with respect to the additive amount. Further, there may be the problems of deterioration in the film-forming properties and the mechanical properties.

### EXAMPLES

As to the first embodiment, Examples 1 to 4 and Comparative Examples 1 to 6 will be described below.

TABLE 1 and TABLE 2 show ultraviolet curable resin compositions used in Examples 1 to 4 and Comparative Examples 1 to 6, respectively.

TABLE 1

| | | | | Examples | | | |
|---|---|---|---|---|---|---|---|
| | | | | 1 | 2 | 3 | 4 |
| Ultraviolet | Oligomer | | *A1 | 50 | 60 | 60 | 70 |
| curable | | | *A2 | | | | |
| resin | Monomer | Alicyclic | *A3 | 25 | 20 | 20 | |
| composition | | monomer | *A4 | | | | 10 |
| | | | *A5 | 5 | 5 | 5 | 5 |
| | | Hydrophilic | *A6 | 20 | 15 | | 15 |
| | | monomer | *A7 | | | 15 | |
| | | Others | *A8 | | | | |
| | | | *A9 | | | | |
| | Photopolymerization | | *A10 | 2 | 2 | 2 | 2 |
| | initiator | | *A11 | 3 | 3 | 3 | 3 |
| | Total | | | 105 | 105 | 105 | 105 |
| | Oligomer ratio (mass %) | | | 47.6 | 57.1 | 57.1 | 66.7 |
| | Hydrophilic monomer ratio (mass %) | | | 19.0 | 14.3 | 14.3 | 14.3 |
| | Viscosity (25° C., mPas) | | | 1200 | 2700 | 2900 | 8200 |
| Hydrous | Additive amount of hydrous water | | | 112 | | | |
| water | absorbent polymer | | | | | | |
| absorbent | Moisture content ratio (%) | | | 50 | | | |
| polymer- | Film | Film forming | 100 μm | ◯ | ◯ | ◯ | ◯ |
| dispersed | | property | thickness | | | | |
| ultraviolet | | | 200 μm | ◯ | ◯ | ◯ | ◯ |
| curable | | | thickness | | | | |

| | | | | | | |
|---|---|---|---|---|---|---|
| resin | | Porosity (%) | 51 | 50 | 48 | 49 |
| composition | | Dielectric constant | 1.69 | 1.7 | 1.8 | 1.73 |
| | | (10 GHz, | | | | |
| | | cavity resonance) | | | | |
| | | a/b | 1 to 1.3 | 1 to 1.4 | 1 to 1.8 | 1 to 1.5 |
| | | 360° bending test | ◯ | ◯ | ◯ | ◯ |
| | Electric | a/b | 1 to 1.6 | 1 to 1.7 | 1 to 1.8 | 1 to 1.8 |
| | wire | Wrapping test | ◯ | ◯ | ◯ | ◯ |
| | | Heat shock after winding | 2 d | 1 d | 1 d | 1 d |
| | | test | | | | |

TABLE 2

| | | | | Comparative Examples | | | | | |
|---|---|---|---|---|---|---|---|---|---|
| | | | | 1 | 2 | 3 | 4 | 5 | 6 |
| Ultraviolet | Oligomer | | *A1 | 40 | 60 | 80 | | | 60 |
| curable | | | *A2 | | | | 60 | 60 | |
| resin | Monomer | Alicyclic | *A3 | 30 | 20 | 10 | | 20 | |
| composition | | monomer | *A4 | | | | | | |
| | | | *A5 | 5 | 5 | | | 5 | |
| | | Hydrophilic | *A6 | 25 | | 10 | | 15 | 15 |
| | | monomer | *A7 | | | | | | |
| | | Others | *A8 | | 15 | | 30 | | 20 |
| | | | *A9 | | | | 10 | | 5 |
| | Photopolymerization | | *A10 | 2 | 2 | 2 | 2 | 2 | 2 |
| | initiator | | *A11 | 3 | 3 | 3 | 3 | 3 | 3 |
| | Total | | | 105 | 105 | 105 | 105 | 105 | 105 |
| | Oligomer ratio (mass %) | | | 38.1 | 57.1 | 76.2 | 57.1 | 57.1 | 57.1 |
| | Hydrophilic monomer | | | 23.8 | 0.0 | 9.5 | 0.0 | 14.3 | 14.3 |
| | ratio (mass %) | | | | | | | | |
| | Viscosity (25° C., mPas) | | | 800 | 2300 | 80000 | 2100 | 2500 | 2300 |
| Hydrous | Additive amount of hydrous water | | | 112 | | | | | |
| water | absorbent polymer | | | | | | | | |
| absorbent | Moisture content ratio (%) | | | 50 | | | | | |
| polymer- | Film | Film | 100 μm | ◯ | X | X | X | ◯ | ◯ |
| dispersed | | forming | thickness | | | | | | |
| ultraviolet | | property | 200 μm | ◯ | X | X | X | ◯ | ◯ |
| curable | | | thickness | | | | | | |

| | | | | | | | | |
|---|---|---|---|---|---|---|---|---|
| resin | | Porosity (%) | 50 | — | — | — | 50 | 48 |
| composition | | Dielectric constant | 1.73 | — | — | — | 1.75 | 1.81 |
| | | (10 GHz, | | | | | | |
| | | cavity resonance) | | | | | | |
| | | a/b | 1 to 1.4 | — | — | — | 1 to 1.4 | 1 to 1.6 |
| | | 360° bending test | X | — | — | — | X | ◯ |
| | Electric | a/b | 1 to 1.7 | — | — | — | 1 to 1.8 | 1 to 1.8 |
| | wire | Wrapping test | ◯ | — | — | — | X | ◯ |
| | | Heat shock after | 6 d | — | — | — | 10 d | 4 d |
| | | winding test | | | | | | |

Each component is generally indicated by parts by mass.
*A1 “UA-4002HM” (using isocyanate H-MDI): manufactured by Shin-Nakamura Chemical Co., Ltd.,
*A2 “M-1100” (using isocyanate TDI): manufactured by Toa Gosei Kagaku Kogyo K.K.,
*A3 Dicyclopentanyl methacrylate: “FA-513M” manufactured by Hitachi Chemical Co., Ltd.,
*A4 Isobornyl methacrylate: “IB-X” manufactured by Kyoeisha Chemical Co., LTD.,
*A5 Dicyclopentenyl diacrylate: “R-684” manufactured by Nippon Kayaku Co., Ltd.,
*A6 N-vinyl pyrrolidone manufactured by Tokyo Chemical Industry Co., Ltd.,
*A7 2-hydroxyethyl methacrylate manufactured by Tokyo Chemical Industry Co., Ltd.,
*A8 Phenoxyethyl acrylate: “P-200A” manufactured by Kyoeisha Chemical Co., LTD,
*A9 1,6-hexanediol diacrylate: “A-HD-N” manufactured by Shin-Nakamura Chemical Co., Ltd.,
*A10 1-hydroxy cyclohexyl phenylketones: “IRGACURE ® 184” manufactured by Ciba Specialty Chemicals K.K.,
*A11 2,4,6-trimethyl benzoyldiphenyl phosphine oxide: “DAROCURE ® TPO” manufactured by Ciba Specialty Chemicals K.K.

A water absorbent polymer formed of polyalkylene oxide based resin (AQUACALK TWB-PF, manufactured by Sumitomo Seika Chemicals Co Ltd.) with preliminarily absorbed distilled water of which water absorption ratio is 31 parts by mass of the distilled water per 1 part by mass of the water absorbent polymer, which is cracked once at a pressure of 130 MPa using a homogenizer PA-2K (manufactured by GEA Niro Soavi S.p.A.) so that an average particle diameter of the hydrous water absorbent polymer is 50 μm, is dispersed as a hydrous water absorbent polymer in the ultraviolet curable resin composition with the added hydrophilic monomer.

112 parts by mass of the hydrous water absorbent polymer was heated to 50° C., was added to each ultraviolet curable resin composition so that the moisture content is 50%, and was agitated and dispersed at a rotation speed of 600 rpm for 30 minutes by an agitator (Three-One Motor).

Then, a film and an electric wire cable were manufactured by using this resin composition. The electric wire cable coated with a film thickness of about 100 μm was manufactured by coating a twisted (stranded) conductor of 48 AWG (American Wire Gauge) (7/0.013, S-MF-AG alloy wire (Cu—Ag based alloy wire) manufactured by Hitachi Cable, Ltd.) with each resin composition at a pressurized coating bath at a speed of 50 m/min, passing it through a UV irradiation furnace (6 kW, two lumps, manufactured by Eye Graphics Co., Ltd.) and dehydrating it by heating.

The evaluating method of Examples and Comparative examples will be explained below.

### <Film-Forming Property>

A thick coating film having a width of 100 mm and a length of 200 mm was formed of the resin composition preheated to 50° C. was formed as on a glass plate using a 7 MIL and 15 MIL blades and radiation was carried out at 500 mJ/cm² under a nitrogen atmosphere by using a UV irradiation conveyer (metal halide lamp with 80 W/cm of output), and it was confirmed as to whether or not a film having a thickness of about 100 μm and 200 μm was formed. The film-forming properties are evaluated as ◯ for a perfect film, and × in case that a film is not formed at all.

### <Porosity>

After the dehydration of the obtained film by heating for 10 minutes using a microwave heating apparatus (with oscillation frequency of 2.45 GHz), the condition was adjusted at 23±2° C., 55% RH for 24 hours, volume and weight were subsequently measured, and the porosity was derived from the following formula.

Porosity (%)={1−(Weight of sample after dehydration/Volume of sample after dehydration)/(Weight of non-hydrated resin sample/Volume of non-hydrated resin sample)}×100.

### <Dielectric Constant>

Film sample (a thickness of 200 μm and dehydrated by heating at 100° C. for 1 hour) was processed in a strip shape having a width of 2 mm and a length of 100 mm. For three film samples, the respective dielectric constants were measured at 10 GHz cavity resonance frequency, and the average thereof was obtained.

<a/b>

Electron micrograms of cross sections of the film (a thickness of 200 μm and dehydrated by heating at 100° C. for 1 hour) and a coating layer of the electric wire cable were observed at five points by using an electron microscope. For pores with a diameter of 10 μm or more, a maximum diameter a and a minimum diameter b of the pore cross sections were measured, and a/b was obtained.

### <360° Bending Test>

After folding the film sample (thickness of 100 μm and 200 μm and dehydrated by heating at 100° C. for 1 hour) in two on one side, the folded film sample was unfolded and further folded in two on the other side. Then, presence of cracks at a bent part was observed. The sample with no crack was evaluated as ◯ and the sample with cracks was evaluated as ×.

### <Winding (Wrapping) Test>

After winding (wrapping) the electric wire sample around a mandrel with the same diameter for five turns by three times (5 turns×3), presence of cracks at a winding part of the coating layer was observed. The sample with no crack was evaluated as ◯ and the sample with cracks was evaluated as ×.

### <Heat Shock After Winding Test>

After winding (wrapping) the electric wire sample around a mandrel having a multiplied diameter of the diameter of the electric wire sample for five turns by three times (5 turns×3), the wound sample was heated at a temperature of 100° C. for one hour. Thereafter, presence of cracks at a winding part of the coating layer was observed. The sample with no crack was evaluated as ◯ and the sample with cracks was evaluated as ×. When the diameter of mandrel was the same as that of the electric wire, it is shown as “1d” Similarly, when the diameter of the mandrel was duplicate (greater by two-times), triplicate (greater by three-times), or the like, they are shows as “2d”, “3d”, or the like.

It was confirmed that, in Examples 1 to 4 and Comparative Examples 1 to 6, the hydrous water absorbent polymer-dispersed ultraviolet curable resin composition according to the first embodiment of the invention can provide a porous substance and an insulated wire, which is excellent in ductility and flexibility and suppresses the crush of the pores in the porous layer and the cracks due to the bending.

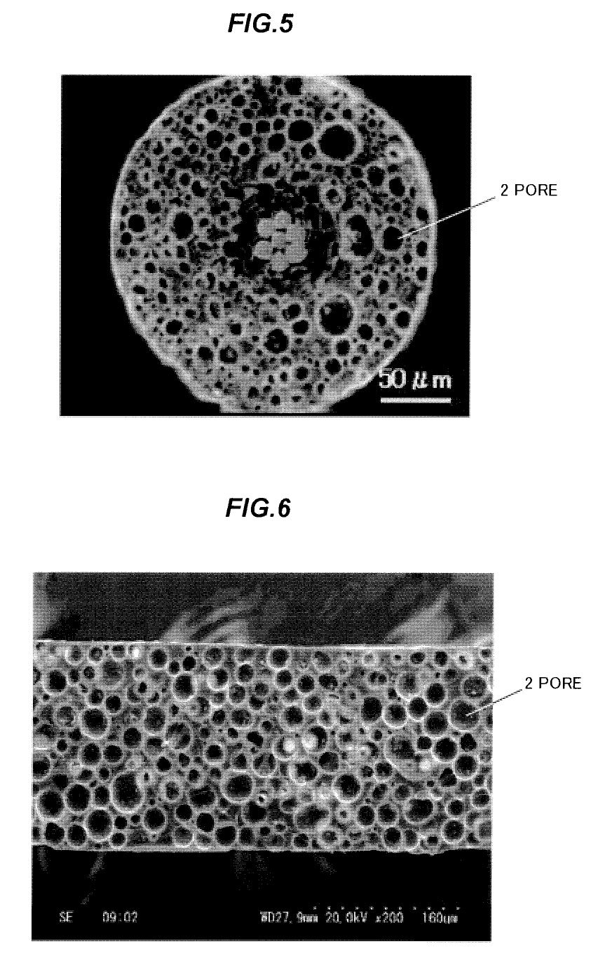

FIG. 4 is a microscope photograph showing a 200-times enlarged cross section of a 200 μm thick film obtained in Example 1 of the first embodiment of the present invention, and FIG. 5 is a microscope photograph showing a 200-times enlarged cross section of a coaxial cable with a 100 μm thick film obtained in Example 1 of the first embodiment of the present invention. From FIGS. 4 and 5, it can be confirmed that the pore 2 formed in the film and the insulation layer of the insulated wire has a substantially spherical shape (i.e. a substantially circular cross section).

Further, it is confirmed that, from the results of Example 1 and Comparative Example 1, the cracks due to the bending easily occurs when a ratio of the oligomer to the ultraviolet curable resin composition is less than 40 mass %.

Still further, it is confirmed that, from the results of Examples 1 to 4 and Comparative Examples 1 to 4, the film cannot be obtained when a ratio of the hydrophilic monomer to the ultraviolet curable resin composition is less than 10 mass %.

In addition, it is confirmed that, from results of Example 2 and Comparative Example 5, the bending resistance property and the thermal shock resistance property can be improved by using the oligomer of the present invention. It is also confirmed that, from results of Examples 2 and 3 and Comparative Example 6, the thermal shock resistance property can be further improved by using the alicyclic monomer.

Although the insulation layer of the porous film covered wire has been exemplary explained in the above-mentioned embodiment, a porous substance (foamed material) obtained by the hydrous water absorbent polymer-dispersed ultraviolet curable resin composition of the invention can be used for a buffering material, a shock absorbing film, a shock absorbing sheet or a light reflecting plate, etc, in addition to the insulation layer.

In addition, since the ultraviolet curable resin composition is a liquid composition, it is possible to apply it on a surface of a deformed object, and to form a porous layer on a surface of various deformed objects.

As to the second embodiment, Examples 5 to 10 and Comparative Examples 7 to 12 will be described below.

TABLE 3 and TABLE 4 show ultraviolet curable resin compositions used in Examples 5 to 10 and Comparative Examples 7 to 12, respectively.

TABLE 3

| | | | | Examples | | | | | |
|---|---|---|---|---|---|---|---|---|---|
| | | | | 5 | 6 | 7 | 8 | 9 | 10 |
| Ultraviolet | Oligomer | | *B1 | 50 | 60 | 60 | 60 | 60 | 70 |
| curable | | | *B2 | | | | | | |
| resin | Monomer | Alicyclic | *B3 | 25 | | 20 | 20 | 20 | |
| composition | | monomer | *B4 | | 20 | | | | 10 |
| | | | *B5 | 5 | 5 | 5 | 5 | 5 | 5 |
| | | Hydrophilic | *B6 | 20 | 15 | 15 | | 15 | 15 |
| | | monomer | *B7 | | | | 15 | | |
| | | Others | *B8 | | | | | | |
| | | | *B9 | | | | | | |
| | Photopolymerization | | *B10 | 2 | 2 | 2 | 2 | 2 | 2 |
| | initiator | | *B11 | 3 | 3 | 3 | 3 | 3 | 3 |
| | Surface | Non-ionic | *B12 | 0.15 | | | | | |
| | active | | *B13 | | 0.05 | | | | |
| | agent | | *B14 | | | 0.1 | | | |
| | | | *B15 | | | | 0.45 | | |
| | | | *B16 | | | | | 0.05 | 0.2 |
| | | Ionic | *B17 | | | | | | |
| | Total | | | 105.15 | 105.05 | 105.1 | 105 | 105.05 | 105.2 |
| | Hydrophilic monomer ratio | | | 19.1 | 14.3 | 14.3 | 14.2 | 14.3 | 14.3 |
| | (mass %) | | | | | | | | |
| | Film-forming property | | 200 μm | ◯ | ◯ | ◯ | ◯ | ◯ | ◯ |
| | | | thickness | | | | | | |
| | Volume resistivity | | 25° C. | 1.2 × 10¹⁵ | 2.0 × 10¹⁵ | 1.1 × 10¹⁵ | 1.5 × 10¹⁵ | 1.7 × 10¹⁵ | 8.1 × 10¹⁴ |
| | (Ω · cm) | | 60° C. | 1.5 × 10¹³ | 3.3 × 10¹³ | 1.4 × 10¹³ | 1.1 × 10¹³ | 2.1 × 10¹³ | 5.3 × 10¹² |
| Hydrous | Additive amount of hydrous water | | | 150 | | | | | |
| water | absorbent polymer | | | | | | | | |
| absorbent | Moisture content ratio (%) | | | 58 | | | | | |
| polymer- | Film | Film | 50 μm | ◯ | ◯ | ◯ | ◯ | ◯ | ◯ |
| dispersed | | forming | thickness | | | | | | |
| ultraviolet | | property | 100 μm | ◯ | ◯ | ◯ | ◯ | ◯ | ◯ |
| curable | | | thickness | | | | | | |
| resin | | | 200 μm | ◯ | ◯ | ◯ | ◯ | ◯ | ◯ |
| composition | | | thickness | | | | | | |
| | | Porosity | 50 μm | 56 | 55 | 55 | 56 | 55 | 56 |
| | | (%) | thickness | | | | | | |
| | | | 100 μm | 56 | 56 | 57 | 56 | 56 | 58 |
| | | | thickness | | | | | | |
| | | | 200 μm | 58 | 57 | 56 | 57 | 57 | 57 |
| | | | thickness | | | | | | |
| | | Pore | 50 μm | 10 to 25 | 10 to 35 | 10 to 30 | 10 to 30 | 5 to 30 | 5 to 25 |
| | | diameter | thickness | | | | | | |
| | | (μm) | 100 μm | 10 to 25 | 10 to 35 | 10 to 30 | 10 to 30 | 5 to 30 | 5 to 25 |
| | | | thickness | | | | | | |
| | | | 200 μm | 10 to 25 | 10 to 35 | 10 to 30 | 10 to 30 | 5 to 30 | 5 to 25 |
| | | | thickness | | | | | | |
| | | 360° | 50 μm | ◯ | ◯ | ◯ | ◯ | ◯ | ◯ |
| | | bending | thickness | | | | | | |
| | | test | 100 μm | ◯ | ◯ | ◯ | ◯ | ◯ | ◯ |
| | | | thickness | | | | | | |
| | | | 200 μm | ◯ | ◯ | ◯ | ◯ | ◯ | ◯ |
| | | | thickness | | | | | | |

| | | | | | | | |
|---|---|---|---|---|---|---|---|
| Electric | Wrapping test | ◯ | ◯ | ◯ | ◯ | ◯ | ◯ |
| wire | Heat shock after | 2 d | 2 d | 1 d | 1 d | 1 d | 1 d |
| | winding test | | | | | | |

TABLE 4

| | | | | Comparative Examples | | | | | |
|---|---|---|---|---|---|---|---|---|---|
| | | | | 7 | 8 | 9 | 10 | 11 | 12 |
| Ultraviolet | Oligomer | | *B1 | 60 | 60 | 60 | | | |
| curable | | | *B2 | | | | 60 | 60 | 60 |
| resin | Monomer | Alicyclic | *B3 | 20 | 20 | | 20 | 20 | |
| composition | | monomer | *B4 | | | 20 | | | |
| | | | *B5 | 5 | 5 | 5 | 5 | | |
| | | Hydrophilic | *B6 | 15 | 15 | | 15 | 15 | 15 |
| | | monomer | *B7 | | | | | | |
| | | Others | *B8 | | | 15 | | | 20 |
| | | | *B9 | | | | | 5 | 5 |
| | Photopolymerization | | *B10 | 2 | 2 | 2 | 2 | 2 | 2 |
| | initiator | | *B11 | 3 | 3 | 3 | 3 | 3 | 3 |
| | Surface | Non-ionic | *B12 | | | | | | |
| | active | | *B13 | | 0.6 | | | | |
| | agent | | *B14 | 0.005 | | | | | |
| | | | *B15 | | | | 0.2 | | |
| | | | *B16 | | | | | | |
| | | Ionic | *B17 | | | | | 0.2 | |
| | Total | | | 105.005 | 105.6 | 105 | 105.2 | 105.2 | 105 |
| | Hydrophilic monomer ratio | | | 14.3 | 14.2 | 0 | 14.3 | 14.3 | 14.3 |
| | (mass %) | | | | | | | | |
| | Film-forming property | | 200 μm | ◯ | Δ | ◯ | ◯ | ◯ | ◯ |
| | | | thickness | | | | | | |
| | Volume resistivity | | 25° C. | 1.9 × 10¹⁵ | — | 1.5 × 10¹⁵ | 7.3 × 10¹⁴ | 8.5 × 10¹² | 3.1 × 10¹⁴ |
| | (Ω · cm) | | 60° C. | 2.6 × 10¹³ | — | 2.6 × 10¹³ | 1.0 × 10¹³ | 1.1 × 10¹¹ | 2.0 × 10¹² |
| Hydrous | Additive amount of hydrous water | | | 150 | | | | | |
| water | absorbent polymer | | | | | | | | |
| absorbent | Moisture content ratio (%) | | | 58 | | | | | |
| polymer- | Film | Film | 50 μm | X | X | X | ◯ | X | X |
| dispersed | | forming | thickness | | | | | | |
| ultraviolet | | property | 100 μm | Δ | X | X | ◯ | ◯ | Δ |
| curable | | | thickness | | | | | | |
| resin | | | 200 μm | ◯ | Δ | X | ◯ | ◯ | ◯ |
| composition | | | thickness | | | | | | |
| | | Porosity | 50 μm | — | — | — | 55 | — | — |
| | | (%) | thickness | | | | | | |
| | | | 100 μm | — | — | — | 57 | 56 | — |
| | | | thickness | | | | | | |
| | | | 200 μm | 56 | — | — | 56 | 57 | 55 |
| | | | thickness | | | | | | |
| | | Pore | 50 μm | — | — | — | 10 to 30 | 10 to 50 | — |
| | | diameter | thickness | | | | | | |
| | | (μm) | 100 μm | — | — | — | 10 to 30 | 10 to 50 | — |
| | | | thickness | | | | | | |
| | | | 200 μm | 20 to 80 | — | — | 10 to 30 | 10 to 50 | 15 to |
| | | | thickness | | | | | | 100 |
| | | 360° | 50 μm | — | — | — | X | X | — |
| | | bending test | thickness | | | | | | |
| | | | 100 μm | — | — | — | X | X | — |
| | | | thickness | | | | | | |
| | | | 200 μm | ◯ | — | — | X | X | X |
| | | | thickness | | | | | | |

| | | | | | | | |
|---|---|---|---|---|---|---|---|
| Electric | Wrapping test | X | — | — | X | X | X |
| wire | Heat shock after winding | 10 d< | — | — | 6 d | 8 d | 10 d< |
| | test | | | | | | |

Each component is generally indicated by parts by mass.
*B1 “UA-4002HM” (using isocyanate H-MDI): manufactured by Shin-Nakamura Chemical Co., Ltd.,
*B2 “M-1100” (using isocyanate TDI): manufactured by Toa Gosei Kagaku Kogyo K.K.,
*B3 Dicyclopentanyl methacrylate: “FA-513M” manufactured by Hitachi Chemical Co., Ltd.,
*B4 Isobornyl methacrylate: “IB-X” manufactured by Kyoeisha Chemical Co., LTD.,
*B5 Dicyclopentenyl diacrylate: “R-684” manufactured by Nippon Kayaku Co., Ltd.,
*B6 N-vinyl pyrrolidone manufactured by Tokyo Chemical Industry Co., Ltd.,
*B7 2-hydroxyethyl methacrylate manufactured by Tokyo Chemical Industry Co., Ltd.,
*B8 Phenoxyethyl acrylate: “P-200A” manufactured by Kyoeisha Chemical Co., LTD,
*B9 1,6-hexanediol diacrylate: “A-HD-N” manufactured by Shin-Nakamura Chemical Co., Ltd.,
*B10 1-hydroxy cyclohexyl phenylketone: “IRGACURE ® 184” manufactured by Ciba Specialty Chemicals K.K.,
*B11 2,4,6-trimethyl benzoyldiphenyl phosphine oxide: “DAROCURE ® TPO” manufactured by Ciba Specialty Chemicals K.K.,
*B12 Perfluoroalkyl radical-containing polyoxy diethyl ether: “F-444” manufactured by DIC Corporation,
*B13 Polyether modified polydimethylsiloxane: “BYK-302” manufactured by BYK Japan KK,
*B14 Aralkyl modified polymethylalkylsiloxane: “BYK-322” manufactured by BYK Japan KK,
*B15 Polyether modified polydimethylsiloxane: “BYK-348” manufactured by BYK Japan KK,
*B16 Polyether modified polymethyl alkylene oxide siloxane: “TSF-4460” manufactured by Momentive Performance Materials, Inc.,
*B17 Perfluoroalkyl radical containing carboxylate: “F-410” manufactured by DIC Corporation.

The method for preparing the samples in Examples 5 to 10 and Comparative Examples 7 to 12 are similar to those in Examples 1 to 4 and Comparative Examples 1 to 6. Only differences therefrom will be explained below.

### <Film-Forming Property>

A thick coating film having a width of 100 mm and a length of 200 mm was formed of the resin composition preheated to 50° C. was formed as on a glass plate using 5 MIL, 7 MIL and 15 MIL blades and radiation was carried out at 500 mJ/cm² under a nitrogen atmosphere by using a UV irradiation conveyer (metal halide lamp with 80 W/cm of output), and it was confirmed as to whether or not a film having a thickness of about 50 μm, 100 μm or 200 μm was formed. The film-forming properties are evaluated as ◯ for a perfect film, Δ as an insufficient film, and × in case that a film is not formed at all.

### <Porosity>

In Examples 5 to 10, the film forming property of all films was good (◯), and the porosity after dehydration by heating was within a range of 50% to 60% for all thicknesses.

### <360° Bending Test>

After folding the film sample (thickness of 50 μm, 100 μm, and 200 μm and dehydrated by heating at 100° C. for 1 hour) in two on one side, the folded film sample was unfolded and further folded in two on the other side. Then, presence of cracks at a bent part was observed.

It is confirmed that no crack occurred in Examples 5 to 10, and cracks occurred in Comparative Examples 7 to 12.

It was confirmed that, in Examples 5 to 10 and Comparative Examples 7 to 12, the hydrous water absorbent polymer-dispersed ultraviolet curable resin composition doped with a predetermined amount of the surface active agent according to the second embodiment of the invention can provide a porous substance and an insulated wire, in which the pore diameter is small since the hydrous water absorbent polymer is finely dispersed. More particularly, it is possible to provide an excellent film-forming property (film formation property) at the thin thickness of 200 μm or less.

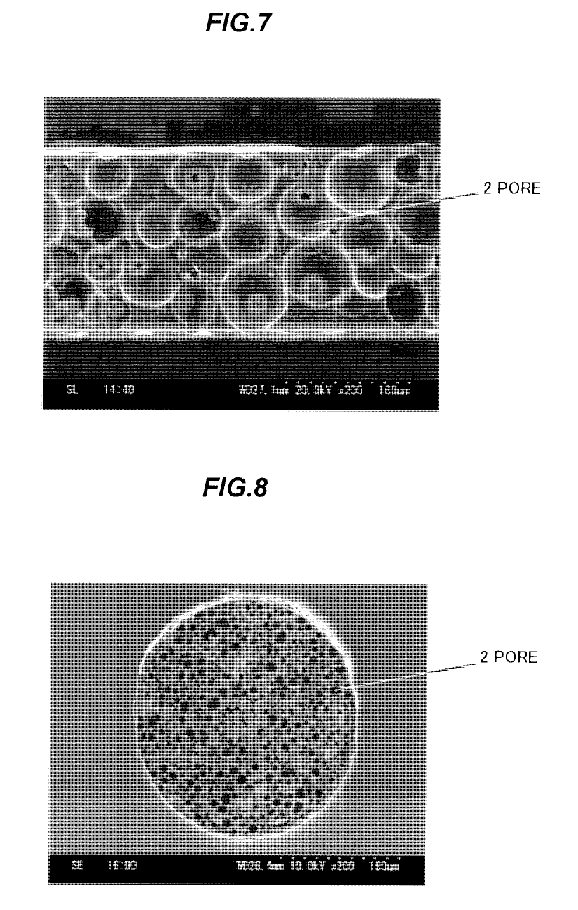

FIG. 6 is a microscope photograph showing a 200-times enlarged cross section of a 200 μm thick film obtained in Example 5 of the second embodiment of the present invention, and FIG. 7 is a microscope photograph showing a 200-times enlarged cross section of a 200 μm thick film obtained in Comparative example 7 of the second embodiment of the present invention. From FIGS. 6 and 7; it can be confirmed that the pore 2 formed in the film of the Example 5 is smaller than that of Comparative Example 7. FIG. 8 is a microscope photograph showing a 200-times enlarged cross section of a coaxial cable with a 100 μm thick film obtained in Example 5 of the second embodiment of the present invention. From FIG. 8, it can be confirmed that the pores 2 are dispersed in the resin composition.

Further, it is confirmed that, from the results of Examples 6 and 7 and Comparative Examples 7 and 8, the dispersion effect cannot be obtained when the additive amount of the surface active agent is too small. On the other hand, the film-forming property is deteriorated when the additive amount of the surface active agent is too much.

Still further, it is confirmed that, from the results of Examples 7 and 8 and Comparative Examples 10 to 12, a porous substance having excellent bending resistance property and thermal shock resistance property compared with urethane oligomer using aromatic isocyanate can be obtained by using the urethane oligomer of the second embodiment.

In addition, it is confirmed that, from results of Comparative Example 11, the electrical properties such as volume resistivity is lowered by using the ionic surface active agent.

Although the invention has been described with respect to the specific embodiment for complete and clear disclosure, the appended claims are not to he therefore limited but are to be construed as embodying all modifications and alternative constructions that may occur to one skilled in the art which fairly fall within the basic teaching herein set forth.

What is claimed is:

1. A hydrous water absorbent polymer-dispersed ultraviolet curable resin composition comprising an ultraviolet curable resin composition having a hydrous water absorbent polymer preliminarily hydrated and swollen which is dispersed therein, an urethane oligomer having a molecular weight of 5000 or less, the urethane oligomer comprising a poly(ethylene-glicol-adipate)diol having a molecular weight of 500 to 3000 and having an acryloyl radical or a methacryloyl radical as a functional radical X at both ends by urethane bond via an alicyclic isocyanate as expressed by a following formula, at least one kind of alicyclic monomer, a hydrophilic monomer, and a photopolymerization initiator,
X—Y—O(CH₂CH₂)ₙOCO(CH₂)₄COO(CH₂CH₂)ₘO—Y—X,
wherein X is CH₂═CRCOO(CH₂)ₐO (R is H or CH₃) and Y is the alicyclic isocyanate.

2. The hydrous water absorbent polymer-dispersed ultraviolet curable resin composition according to claim 1, further comprising:
0.01 mass % to 0.5 mass % of a non-ionic fluorine based surface active agent or a non-ionic silicone-based surface active agent.

3. The hydrous water absorbent polymer-dispersed ultraviolet curable resin composition according to claim 1, wherein the alicyclic isocyanate comprises a methylenebis (4-cyclohexyl isocyanate).

4. The hydrous water absorbent polymer-dispersed ultraviolet curable resin composition according to claim 1, wherein a ratio of the oligomer in the ultraviolet curable resin except the hydrous water absorbent polymer is 40 mass % to 70 mass %, and a ratio of the hydrophilic monomer is 10 mass % or more.

5. The hydrous water absorbent polymer-dispersed ultraviolet curable resin composition according to claim 1, wherein, the hydrophilic monomers comprises at least one selected from the group consisting of vinyl pyrrolidone, N,N-dimethylaminoethyl methacrylate, 2-hydroxyethyl acrylate, 2-hydroxyethyl methacrylate and hydroxypropyl acrylate.

6. The hydrous water absorbent polymer-dispersed ultraviolet curable resin composition according to claim 1, wherein a viscosity of the ultraviolet curable resin except the hydrous water absorbent polymer at a temperature of 25° C. is 1 to 10 Pas.

7. The hydrous water absorbent polymer-dispersed ultraviolet curable resin composition according to claim 1, wherein a moisture content in the hydrous water absorbent polymer-dispersed ultraviolet curable resin composition is 20 mass % or more.

8. The hydrous water absorbent polymer-dispersed ultraviolet curable resin composition according to claim 1, wherein a particle diameter of the hydrous water absorbent polymer is 30 μm or less

9. The hydrous water absorbent polymer-dispersed ultraviolet curable resin composition according to claim 2, wherein the non-ionic fluorine based surface active agent or the non-ionic silicone-based surface active agent comprises at least one selected from the group consisting of perfluoroalkyl radical-containing polyoxyethylene ether, polyether-modified polydimethylsiloxane, and polyether-modified polymethyl alkylsiloxane.

10. A porous substance, formed by curing the hydrous water absorbent polymer-dispersed ultraviolet curable resin composition according to claim 1 and dehydrating the hydrous water absorbent polymer to provide a pore in the ultraviolet curable resin composition.

11. An insulated wire, comprising:
an insulation layer formed by coating an outer periphery of stranded conductors with the porous substance according to claim 10.

12. The insulated wire according to claim 11, wherein a thickness of the insulation layer is not more than 200 μm, and a porosity thereof is 20% to 60%.

13. The insulated wire according to claim 11, wherein a cross section of the pore that forms a void in the insulation layer is in a substantially circular cross section, a ratio of a maximum diameter portion thereof and a minimum diameter portion of the pore is not more than 2, and a pore size D in a thickness direction is formed so as to be D<½ t where a thickness of the insulation layer is t.

14. A multilayer covered cable, comprising:
a skin layer provided on an outer periphery of the insulated wire according to claim 11.

15. A coaxial cable, comprising:
a metal layer provided on an outer periphery of the insulated wire according to claim 11.

16. A porous substance, formed by curing the hydrous water absorbent polymer-dispersed ultraviolet curable resin composition according to claim 2 and dehydrating the hydrous water absorbent polymer to provide a pore in the ultraviolet curable resin composition.

17. An insulated wire, comprising:
an insulation layer formed by coating an outer periphery of stranded conductors with the porous substance according to claim 16.

18. The insulated wire according to claim 17, wherein a thickness of the insulation layer is not more than 200 μm, and a porosity thereof is 20% to 60%.

19. The insulated wire according to claim 17, wherein a cross section of the pore that forms a void in the insulation layer is in a substantially circular cross section, a ratio of a maximum diameter portion thereof and a minimum diameter portion is not more than 2, and a pore size D in a thickness direction is formed so as to be D<½ t where a thickness of the insulation layer is t.

20. A multilayer covered cable, comprising:
a skin layer provided on an outer periphery of the insulated wire according to claim 17.

21. A coaxial cable, comprising:
a metal layer provided on an outer periphery of the insulated wire according to claim 17.

22. A method of manufacturing a porous substance, comprising
dispersing a hydrous water absorbent polymer preliminarily hydrated and swollen in an ultraviolet curable resin composition comprising an urethane oligomer having a molecular weight of 5000 or less, the urethane oligomer comprising a poly(ethylene-glicol-adipate)diol having a molecular weight of 500 to 3000 and having an acryloyl radical or a methacryloyl radical as a functional radical X at both ends by urethane bond via an alicyclic isocyanate, at least one kind of alicyclic monomer, a hydrophilic monomer, and a photopolymerization initiator,
curing the hydrous water absorbent polymer-dispersed ultraviolet curable resin composition, and
heating the cured resin composition for removing moisture in the hydrous water absorbent polymer to provide a pore in the cured resin composition.

23. The method of manufacturing the porous substance according to claim 22, wherein the hydrous water absorbent polymer is dispersed in the ultraviolet curable resin composition after doping 0.01 mass % to 0.5 mass % of a non-ionic fluorine based surface active agent or a non-ionic silicone-based surface active agent to the ultraviolet curable resin composition.

24. The method of manufacturing the porous substance according to claim 22, wherein a microwave heating is used as the heating.

25. A method of manufacturing an insulated wire, comprising:
coating an outer periphery of a conductor with a hydrous water absorbent polymer-dispersed ultraviolet curable resin composition comprising an ultraviolet curable resin composition having a hydrous water absorbent polymer preliminarily hydrated and swollen which is dispersed therein, an urethane oligomer having a molecular weight of 5000 fi or less, the urethane oligomer comprising a poly(ethylene-glicol-adipate)diol having a molecular weight of 500 to 3000 and having an acryloyl radical or a methacryloyl radical as a functional radical X at both ends by urethane bond via an alicyclic isocyanate as expressed by a following formula, at least one kind of alicyclic monomer, a hydrophilic monomer, and a photopolymerization initiator,
forming an insulation layer by curing the resin composition, and
heating the cured resin composition for removing moisture in the insulation layer, thereby forming pores in the insulation layer.

26. The method of manufacturing the porous substance according to claim 25, wherein the hydrous water absorbent polymer is dispersed in the ultraviolet curable resin composition after doping 0,01 mass % to 0.5 mass % of a non-ionic fluorine based surface active agent or a non-ionic silicone-based surface active agent to the ultraviolet curable resin composition.

27. The method of manufacturing the porous substance according to claim 25, wherein a microwave heating is used as the heating.
